(19) United States
(12) Patent Application Publication
(10) Pub. No.: US 2025/0256269 A1
(43) Pub. Date: Aug. 14, 2025

(54) PHOTOCATALYTIC PAINT, PHOTOCATALYST COATING METHOD, AND PHOTOCATALYST-COATED ARTICLE

(71) Applicant: SHARP KABUSHIKI KAISHA, Osaka (JP)

(72) Inventors: YOSHITAKA KAWASE, Osaka (JP); Naoki Shiba, Osaka (JP); Tomoya Tsutsumino, Osaka (JP); Tatsufumi Atsumi, Osaka (JP); Yoshiki Kato, Osaka (JP)

(21) Appl. No.: 19/020,143

(22) Filed: Jan. 14, 2025

(30) Foreign Application Priority Data
Feb. 8, 2024 (JP) 2024-018132

(51) Int. Cl. B01J 31/06; B01J 23/30; B01J 23/42; B01J 31/34; B01J 35/39; B01J 37/02

(52) U.S. Cl. CPC B01J 31/069; B01J 23/30; B01J 23/42; B01J 31/34; B01J 35/39; B01J 37/0219; B01J 37/0236

(57) ABSTRACT

A photocatalytic paint according to the disclosure includes: photocatalytic particles containing tungsten oxide; a binder; and an aqueous dispersion medium. The binder includes a first binder and a second binder, or a dehydrated condensate of the first binder and the second binder. The first binder is a compound containing a trihydroxysilane group or a dehydrated condensate of the compound, and the second binder is an aliphatic hydroxy acid or an aldonic acid.

### INCORPORATION BY REFERENCE

Under Section 119 of U.S.C., the present application claims priority to JP 2024-018132 filed on Feb. 8, 2024, the entire content of which is incorporated herein by reference.

### BACKGROUND

The disclosure relates to a photocatalytic paint, a photocatalyst coating method, and a photocatalyst-coated article.

Photocatalytic particles are particles that exhibit photocatalytic activity in response to the reception of light. Using this photocatalytic activity, photocatalytic particles can, for example, decompose harmful substances in the air, decompose offensive odor-causing substances, decompose pollutants dissolved or dispersed in water, decompose fungi, inhibit the growth of fungi, inhibit the dirtying of exterior walls, and inhibit the dirtying of windows.

In order to use this photocatalytic activity, the photocatalytic particles must be fixed to a base material. For example, WO 2011/059101 A1 discloses an antifouling acrylic board formed from an acrylic base material, a silica layer formed on the surface thereof, and a photocatalyst layer further formed thereon. A binding layer composed of a silane coupling agent is provided between the surface of the acrylic base material and the silica layer.

### SUMMARY

The disclosure provides a photocatalytic paint including: photocatalytic particles containing tungsten oxide; a binder; and an aqueous dispersion medium, wherein the binder includes a first binder and a second binder, or includes a dehydrated condensate of the first binder and the second binder, the first binder is a compound containing a trihydroxysilane group, or a dehydrated condensate of the compound, and the second binder is an aliphatic hydroxy acid or an aldonic acid.

### Advantageous Effects of Invention

Through the use of the photocatalytic paint of the disclosure, a photocatalyst layer having excellent durability and water resistance can be formed while maintaining photocatalytic activity and stability of the paint over time.

### BRIEF DESCRIPTION OF DRAWINGS

FIG. 1 is an explanatory view of a method for forming a photocatalyst layer using a photocatalytic paint according to one embodiment of the disclosure.

FIG. 2 is a conceptual diagram of a photocatalyst-coated article according to one embodiment of the disclosure.

### DETAILED DESCRIPTION

The photocatalytic paint of the disclosure includes: photocatalytic particles containing tungsten oxide; a binder; and an aqueous dispersion medium, wherein the binder includes a first binder and a second binder, or includes a dehydrated condensate of the first binder and the second binder, the first binder is a compound containing a trihydroxysilane group, or a dehydrated condensate of the compound, and the second binder is an aliphatic hydroxy acid or an aldonic acid.

The compound containing a trihydroxysilane group is preferably a compound represented by chemical formula (1): R₁—Si(OH)₃ [where R₁ represents an organic group having an epoxy group, an organic group having an amino group, an organic group having a methacryl group, or an organic group having a mercapto group], and the second binder is preferably a compound having from 1 to 5 hydroxy groups and from 1 to 3 carboxyl groups.

R₁ in chemical formula (1) preferably represents a 3-glycidoxypropyl group, a 3-aminopropyl group, a 3-methacryloxypropyl group, or a 3-mercaptopropyl group.

A ratio (b/a) of a mass (b) of the binder to a total mass (a) of the photocatalytic particles and the binder in the photocatalytic paint is preferably from (1/100) to (25/100).

A ratio (c/a) of a mass (c) of the photocatalytic particles to the total mass (a) of the photocatalytic particles and the binder in the photocatalytic paint is preferably from (75/100) to (99/100).

A ratio (e/d) of a mass (e) of the second binder to a mass (d) of the first binder in the photocatalytic paint is preferably from (5/95) to (40/60).

The second binder is preferably gluconic acid, citric acid, malic acid, or lactic acid.

The photocatalytic paint of the disclosure preferably further contains a preservative, and the preservative preferably includes at least one of copper ions, silver ions, or zinc ions.

The disclosure also provides a photocatalyst coating method including forming a coating layer by applying the photocatalytic paint of the disclosure onto a base material, and naturally drying the coating layer.

The disclosure also provides a photocatalyst-coated article containing a base material and a photocatalyst layer provided on the base material, wherein the photocatalyst layer contains photocatalytic particles containing tungsten oxide, and a dehydrated condensate of a first binder and a second binder, the first binder is a compound containing a trihydroxysilane group, or a dehydrated condensate of the compound, and the second binder is an aliphatic hydroxy acid or an aldonic acid.

The disclosure is explained in more detail below with reference to a plurality of embodiments. The configurations presented in the drawings and following description are merely examples, and the scope of the disclosure is not limited to the configurations presented in the drawings and following description.

### First Embodiment: Photocatalytic Paint

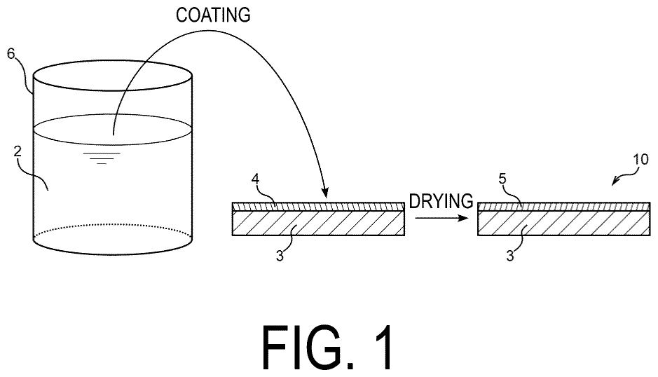

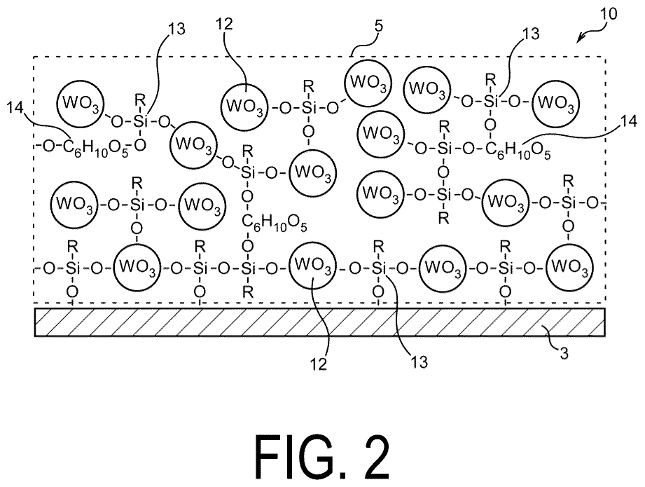

FIG. 1 is an explanatory view of a method for producing a photocatalyst-coated body using a photocatalytic paint of the present embodiment, and FIG. 2 is a conceptual diagram of a photocatalyst-coated article.

A photocatalytic paint 2 of the present embodiment includes: photocatalytic particles 12 containing tungsten oxide; a binder; and an aqueous dispersion medium. The binder includes a first binder and a second binder, or includes a dehydrated condensate of the first binder and the second binder, the first binder is a compound containing a trihydroxysilane group, or a dehydrated condensate of the compound, and the second binder is an aliphatic hydroxy acid or an aldonic acid. A photocatalyst layer 5 can be formed by applying the photocatalytic paint 2 of the present embodiment onto a base material 3 to form a coating layer 4, and then drying the coating layer 4.

The photocatalytic paint 2 may be a suspension containing the photocatalytic particles 12 dispersed in an aqueous dispersion medium. As necessary, the photocatalytic paint 2 may further contain a preservative containing at least one of copper ions, silver ions, or zinc ions. The photocatalytic paint 2 is a water-based paint containing water. Examples of the solvent (or dispersion medium) in the photocatalytic paint 2 include water and a mixed liquid of water and ethanol. Through the use of such a solvent, the environmental load can be reduced, and the working environment can be improved.

The compound containing a trihydroxysilane group and serving as the first binder is, for example, a compound represented by chemical formula (1): R₁—Si(OH)₃. The first binder is obtained, for example, by hydrolyzing a compound (R₁—Si(OCₙH₂ₙ₊₁)₃) containing a trialkoxysilane group. The number n of carbon atoms is preferably from 2 to 8. The alkoxy group (CₙH₂ₙ₊₁O—) is, for example, an ethoxy group (C₂H₅O—) and is converted into a hydroxyl group (—OH) (silanol group SiOH) and ethanol through a hydrolysis reaction.

Moreover, the first binder may be a dehydrated condensate of the compound represented by chemical formula (1). In the dehydration-condensation reaction of the first binder, a hydroxyl group (silanol group) included in one compound reacts with a hydroxyl group (silanol group) included in another compound to generate water (H₂O), and two silicon atoms are bonded to each other via a siloxane bond. For example, a reaction represented by the reaction equation: 2R₁—Si(OH)₃→R₁—Si(OH)₂OSi(OH)₂—R₁+H₂O proceeds, and a dehydrated condensate serving as the first binder is generated along with water.

In the photocatalytic paint 2, part of the first binder may be chemically bonded to the second binder or the photocatalytic particles 12 through a dehydration-condensation reaction.

R₁ in chemical formula (1) represents, for example, an organic group having an epoxy group, an organic group having an amino group, an organic group having a methacryl group, or an organic group having a mercapto group. In addition, R₁ in chemical formula (1) may represent a 3-glycidoxypropyl group, a 3-aminopropyl group, a 3-methacryloxypropyl group, or a 3-mercaptopropyl group.

In the process of forming the photocatalyst layer 5, the OH group of the first binder and the OH group of the second binder undergo a dehydration-condensation reaction to form a siloxane compound (binder). In addition, the first binder undergoes a dehydration-condensation reaction with the hydroxy groups (OH) on the surfaces of the photocatalytic particles 12 containing tungsten oxide as a main component and thereby bonds with the hydroxy groups. The first binder is also bonded to hydroxy groups (OH) on the surface of the base material 3 through a dehydration-condensation reaction. Further, the first binder also easily bonds with the metal ions of the preservative. Therefore, the first binder can firmly adhere to the preservative, the photocatalytic particles 12, the base material 3 (for example, metal, metal oxide, glass, and plastic), and the like. Accordingly, the amount of the binder required for forming the photocatalyst layer 5 is small compared to the amount of the photocatalytic particles 12, and thus impairment of the photocatalytic function of the photocatalytic particles 12 can be suppressed.

The aliphatic hydroxy acid (hydroxycarboxylic acid, oxyacid, or alcoholic acid) serving as the second binder is a compound having a carboxyl group (—COOH) and an alcoholic hydroxyl group (—OH) in one molecule and not having a six-membered ring composed of six carbon atoms. Moreover, the aldonic acid serving as the second binder is a polyhydroxy carboxylic acid obtained by oxidizing an aldehyde group of an aldose. The second binder is, for example, a compound represented by chemical formula (2): (HOOC)ₐR₂(OH)_{b}. The second binder may be a compound having from 1 to 5 hydroxy groups (b=1 to 5) and from 1 to 3 carboxyl groups (a=1 to 3). The second binder is, for example, gluconic acid (HOOC—CH(OH)—CH(OH)—CH(OH)—CH(OH)—CH₂OH), citric acid (HOOC—CH₂—C(OH)(COOH)—CH₂—COOH), malic acid (HOOC—CH(OH)—CH₂COOH) or lactic acid (H₃C—CH(OH)COOH), and gluconic acid, which has a large number of OH groups, is particularly preferable. The second binder may be a non-volatile substance or a compound with low volatility. Thereby, the pH of the photocatalytic paint 2 can be stabilized, and the photocatalytic paint 2 can exhibit stability over time. The second binder is an acidic substance, and therefore the photocatalytic paint 2 is acidic. Moreover, in the photocatalytic paint 2, part of the second binder may be chemically bonded to the first binder or the photocatalytic particles 12 through a dehydration-condensation reaction.

The photocatalytic particles 12 are particles containing tungsten oxide as a main component and are, for example, tungsten oxide particles. Moreover, the photocatalytic particles 12 may be tungsten oxide particles having a catalytic promoter on the surface thereof. In the photocatalytic paint 2, some of the photocatalytic particles 12 may be chemically bonded with the first binder or the second binder through a dehydration-condensation reaction.

The photocatalytic particles 12 exhibit photocatalytic activity in a short wavelength range of visible light. Specifically, when the photocatalytic particles 12 are irradiated with light having energy equal to or greater than the energy gap between the valence band and the conduction band, electrons in the valence band of the photocatalytic particles 12 are excited to the conduction band, and holes are generated in the valence band. The excited electrons reduce oxygen to thereby produce a superoxide anion. In addition, the generated holes oxidize water to generate hydroxyl radicals. Reactive oxygen species are then generated by the generated hydroxy radicals. Moreover, for example, decomposition of harmful substances, antibacterial activity, and antifouling activity are achieved through the generated reactive oxygen species.

The tungsten oxide contained in the photocatalytic particles 12 is not particularly limited, and a commercially available product can be appropriately used as the tungsten oxide. Examples of the tungsten oxide include WO₃ (tungsten trioxide), WO₂, WO, W₂O₃, W₄O₅, W₄O₁₁, W₂₅O₇₃, W₂₀O₅₈, W₂₄O₆₈, and mixtures thereof. WO₃ is preferable as the tungsten oxide when an improvement in the photocatalytic activity of the photocatalyst layer 5 is desired. The tungsten oxide may be partially reduced to a valence of V However, tungsten oxide is preferably used after being oxidized to a valence of VI. An example of a method for oxidizing tungsten oxide to a valence of VI is a method of firing tungsten oxide at a high temperature. Note that the crystal structure of tungsten oxide is not particularly limited.

The average particle size of the photocatalytic particles 12 containing tungsten oxide as a main component is preferably from 5 nm to 200 nm. Such an average particle size makes it difficult for the photocatalytic particles 12 to aggregate and facilitates re-dispersion. When the average particle size of the photocatalytic particles 12 is equal to or less than 200 nm, the photocatalytic particles 12 tend to be uniformly mixed with other paint components, and separation of the photocatalytic particles 12 from the photocatalyst layer 5 formed by the photocatalytic paint 2 can be suppressed. The average particle size is a value calculated based on the specific surface area (unit: m²/g) of the particles measured by the BET method and on the assumption that the primary particles of the particles are spherical.

The photocatalytic particles 12 containing tungsten oxide as a main component preferably have catalytic promoter particles on the surface thereof. As the catalytic promoter particles, metal particles are preferable, transition metal particles are more preferable, and platinum group metal particles are still more preferable. Platinum group metal particles include, for example, particles of Pt, Pd, Rh, Ru, Os, and Jr. When the catalytic promoter particles are provided on the surfaces of the tungsten oxide particles, the energy gap between the valence band and the conduction band of the tungsten oxide particles can be reduced, and light responsiveness in the visible light range can be improved.

The photocatalytic paint 2 preferably further contains a preservative in addition to the binder, water, and photocatalytic particles 12 containing tungsten oxide as a main component. The preservative may contain copper ions, silver ions, or zinc ions. As the raw material, a water-soluble copper, silver, or zinc compound may be used.

A ratio (b/a) of a mass (b) of the first and second binders to a total mass (a) of the photocatalytic particles 12 and the first and second binders in the photocatalytic paint 2 is, for example, from (1/100) to (25/100). Moreover, a ratio (c/a) of a mass (c) of the photocatalytic particles 12 to the total mass (a) of the photocatalytic particles 12 and the first and second binders in the photocatalytic paint 2 is, for example, from (75/100) to (99/100). With such ratios, the photocatalyst layer 5 formed by applying and drying the photocatalytic paint 2 is durable and water resistant and can exhibit high photocatalytic activity.

When the coating layer 4 is dried, the binder including the first binder and the second binder or a dehydrated condensate thereof undergoes a dehydration-condensation reaction with the photocatalytic particles 12 and is also dehydrated and condensed with the base material 3, and thereby the plurality of photocatalytic particles 12 and the base material 3 are strongly bonded to each other through the siloxane compound (binder). Therefore, even when the content of the photocatalytic particles 12 in the photocatalyst layer 5 is high, or in other words, even when the content of the binder is low, the photocatalytic particles 12 and the base material 3 are strongly bonded to each other through the binder (siloxane compound). Thus, the addition amount of the binder including the first binder and the second binder, which are the binders of the photocatalytic paint 2, can be reduced. Accordingly, impairment of the photocatalytic activity of the photocatalyst layer 5 by the siloxane compound (binder) and embedding of the photocatalytic particles 12 in the siloxane compound (binder) can both be suppressed. As a result, the photocatalytic activity of the photocatalyst layer 5 can be particularly improved while improving the water resistance and durability of the photocatalyst layer 5.

A ratio (e/d) of a mass (e) of the second binder to a mass (d) of the first binder in the photocatalytic paint 2 is, for example, from (5/95) to (40/60). With such a ratio, the photocatalytic paint 2 is acidic, and when the coating layer 4 formed by applying the photocatalytic paint 2 is dried, the dehydration-condensation reaction between the first binders, the dehydration-condensation reaction between the first binder and the second binder, the dehydration-condensation reaction between the first binder and the photocatalytic particles 12, and the dehydration-condensation reaction between the first binder and the base material 3 can proceed. Thereby, the photocatalyst layer 5 formed by drying the coating layer 4 can exhibit durability and water resistance.

### Second Embodiment: Method for Producing Photocatalytic Paint

A second embodiment of the disclosure relates to a method for producing a photocatalytic paint 2. The photocatalytic paint 2 produced by the production method of the second embodiment is the photocatalytic paint 2 of the first embodiment. For the same reasons as described in the first embodiment, a photocatalyst layer 5 formed using the photocatalytic paint 2 produced by the production method of the second embodiment is excellent in water resistance and durability while maintaining photocatalytic activity. The method for producing the photocatalytic paint 2 of the second embodiment includes, for example, a paint preparation step.

### Paint Preparation Step

In the paint preparation step, a first binder or a raw material thereof, a second binder, photocatalytic particles 12 containing tungsten oxide as a main component, and an aqueous dispersion medium are mixed to obtain the photocatalytic paint 2 of the first embodiment. In order to improve dispersibility, the first and second binders are preferably mixed with the photocatalytic particles 12 containing tungsten oxide as a main component. The photocatalytic particles 12 containing tungsten oxide as a main component may be added in a state of a photocatalyst liquid containing the photocatalytic particles 12 and the dispersion medium. Examples of the aqueous dispersion medium include water and a mixed liquid of water and an alcohol (for example, methanol, ethanol, propanol, or the like).

A solution containing the first and second binders is obtained by mixing a trialkoxysilane group-containing compound as a raw material of the first binder with the second binder and then hydrolyzing the trialkoxysilane group-containing compound, after which the solution thereof may be used to prepare the photocatalytic paint 2. Since the second binder is an acidic substance, the mixed liquid is acidic, and the hydrolysis reaction of the trialkoxysilane group-containing compound proceeds relatively quickly.

Moreover, the trialkoxysilane group-containing compound may be used to prepare the photocatalytic paint 2, and in the preparation of the photocatalytic paint 2, the trialkoxysilane group-containing compound may be hydrolyzed to generate the first binder. Since the photocatalytic paint 2 contains the second binder, which is an acidic substance, the hydrolysis reaction of the compound containing a trialkoxysilane group proceeds relatively quickly.

The trialkoxysilane group-containing compound (R₁—Si(OCₙH₂ₙ₊₁)₃) serving as the raw material of the first binder is not water-soluble, but the hydrolysate thereof from which alcohol has been eliminated by a hydrolysis reaction is water-soluble. Therefore, whether hydrolysis of the trialkoxysilane group-containing compound has been completed can be visually confirmed. Moreover, since the aqueous solution containing the second binder is acidic, an alcohol elimination reaction (hydrolysis reaction) of the raw material of the first binder can be promoted, and the OH group of the second binder can be bonded through dehydration condensation to the silanol group (hydroxyl group) of the first binder after the alcohol elimination. Furthermore, since the second binder is a non-volatile compound or a compound with low volatility, the pH of the photocatalytic paint 2 is stabilized, and therefore state stabilization of the first binder after hydrolysis and dispersion stabilization of the photocatalytic particles 12 can be maintained, and the film quality and photocatalytic performance of the paint after application can be maintained at the initial level over time.

### Third Embodiment: Photocatalyst-Coated Article

A photocatalyst-coated article 10 of the present embodiment contains a base material 3 and a photocatalyst layer 5 provided on the base material 3, wherein the photocatalyst layer 5 contains photocatalytic particles 12 containing tungsten oxide and dehydrated condensates 13, 14 (siloxane compounds) of a first binder and a second binder, the first binder is a compound containing a trihydroxysilane group, or a dehydrated condensate of the compound, and the second binder is an aliphatic hydroxy acid or an aldonic acid. The photocatalyst layer 5 may have a configuration as shown in FIG. 2, for example.

Examples of the material of the base material 3 (specifically, the support) include glass, plastic, metal, ceramics, wood, stone, cement, concrete, fiber, fabric, paper, leather, and combinations thereof. The base material 3 may be a laminate provided with a plurality of layers of different materials. The material of the base material 3 may be a material having a hydroxy group on the surface thereof.

The photocatalyst layer 5 is provided on the base material 3. The photocatalyst layer 5 may be disposed directly on the base material 3. Alternatively, the photocatalyst layer 5 may be disposed on the base material 3 with a primer layer therebetween. The primer layer is formed of, for example, an undercoating agent.

The dehydrated condensates 13, 14 (siloxane compounds) of the first binder and the second binder function as binders that bind the plurality of photocatalytic particles 12 included in the photocatalyst layer 5. The first binder can chemically bind with the photocatalytic particles 12 through a dehydration-condensation reaction with hydroxyl groups on the surfaces of the photocatalytic particles 12. Therefore, the dehydrated condensates 13, 14 are chemically bonded to the plurality of photocatalytic particles 12 contained in the photocatalyst layer 5, and thereby the plurality of photocatalytic particles 12 can be strongly bonded.

In addition, the dehydrated condensates 13, 14 (siloxane compounds) of the first binder and the second binder also function as binders that bind the plurality of photocatalytic particles 12 included in the photocatalyst layer 5 with the base material 3. The first binder can be chemically bonded to the base material 3 by a dehydration-condensation reaction with a hydroxyl group on the surface of the base material 3 (or the primer layer). Therefore, the dehydrated condensates 13, 14 are chemically bonded to the plurality of photocatalytic particles 12 contained in the photocatalyst layer 5 and to the base material 3, and thereby the plurality of photocatalytic particles 12 and the base material 3 can be strongly bonded. Therefore, the photocatalyst layer 5 can exhibit excellent durability and excellent water resistance. In addition, the amount of the dehydrated condensates 13 and 14 (siloxane compounds) contained in the photocatalyst layer 5 can be reduced, and the photocatalyst layer 5 can exhibit excellent photocatalytic activity.

Since the photocatalyst-coated article 10 excels in water resistance and durability and has excellent photocatalytic activity in this manner, the photocatalyst-coated article 10 can suitably exhibit photocatalytic activity in any environment such as indoors, outdoors, in air, and in water.

### Fourth Embodiment: Photocatalyst Coating Method

The photocatalyst coating method of the present embodiment includes a coating step of applying the photocatalytic paint 2 of the first embodiment onto a base material 3 to form a coating layer 4, and a drying step of drying the coating layer 4. A photocatalyst-coated article 10 can be produced by this photocatalyst coating method. For example, a photocatalyst-coated article 10 can be produced as shown in FIG. 1. The photocatalyst coating method of the present embodiment may include a surface treatment step of subjecting the base material 3 to a surface treatment.

### Surface Treatment Step

Before the photocatalytic paint 2 is applied onto the base material 3, the base material 3 can be subjected to hydrophilic surface modification. By hydrophilic surface modification of the base material 3, the wettability of the photocatalytic paint 2 with respect to the base material 3 is improved, and a photocatalyst layer 5 having a more uniform film thickness can be formed. Examples of the method for hydrophilic surface modification of the base material 3 include a chemical treatment, a mechanical treatment, a corona treatment, a flame treatment, an ultraviolet irradiation treatment, a high-frequency treatment, a glow discharge treatment, a plasma treatment, a laser treatment, a mixed acid treatment, and an ozone oxidation treatment. Another example of the method for hydrophilic surface modification of the base material 3 is a method of applying an undercoating agent onto the base material 3 to form a primer layer on the base material 3. Among these methods, a plasma treatment, an ultraviolet irradiation treatment, a corona treatment, or a glow discharge treatment is preferable, and an ultraviolet irradiation treatment is more preferable.

An example of the ultraviolet irradiation treatment will be described. The surface of the base material 3 is irradiated with ultraviolet light using a device that irradiates ultraviolet light. In this manner, the surface of the base material 3 is irradiated with ultraviolet light to hydrophilically modify the surface of the base material 3 before the photocatalytic paint 2 is applied onto the base material 3. The wavelength of the ultraviolet light is preferably from 150 nm to 350 nm, and more preferably from 200 nm to 300 nm because such wavelengths facilitate hydrophilic surface modification of the base material 3. The device for irradiating ultraviolet light is not particularly limited, and a known device can be appropriately used. Examples of the light source of ultraviolet light include a low-pressure mercury lamp and an excimer lamp. The wavelengths (k) of the ultraviolet light emitted from the low-pressure mercury lamp are, for example, 254 nm and 185 nm. The wavelengths (k) of the ultraviolet light irradiated from the excimer lamp are, for example, at least one of the wavelengths of 308 nm (XeCl* lamp), 227 nm (KRCl* lamp), 172 nm (Xe₂* lamp), 126 nm (AR₂* lamp), or 146 nm (KR₂* lamp). The ultraviolet irradiation time varies depending on details such as the irradiance and irradiation conditions, but is, for example, from 1 minute to 1 hour.

### Coating Step

In this step, the photocatalytic paint 2 is applied onto the base material 3 to form the coating layer 4.

The method of applying the photocatalytic paint 2 onto the base material 3 is not particularly limited. Examples of the method for applying the photocatalytic paint 2 onto the base material 3 include a spin coating method, a dip method, a spray method, a roll coating method, a gravure method, a wire bar method, an air knife method, and an ink jet method. Note that the photocatalytic paint 2 may be applied onto at least a part of the base material 3. Also note that the thickness of the photocatalyst layer 5 to be formed is not particularly limited. Regardless of the thickness of the photocatalyst layer 5 obtained by any application method, the photocatalyst layer 5 can exhibit excellent durability.

### Drying Step

In this step, the coating layer 4 is dried. The method of drying the photocatalytic paint 2 (coating layer 4) applied to the base material 3 is not particularly limited. Examples of methods for drying the photocatalytic paint 2 (coating layer 4) applied to the base material 3 include normal temperature drying, aeration drying, forced drying using a dryer, and firing. The temperature at which the photocatalytic paint 2 (coating layer 4) applied to the base material 3 is dried is preferably from 20° C. to 150° C.

In the drying step, the aqueous dispersion medium contained in the coating layer 4 is gradually evaporated to reduce the water content. As a result, the first binder and the second binder contained in the coating layer 4 are concentrated, and a dehydration-condensation reaction between the hydroxyl groups (silanol groups) of one first binder and hydroxyl groups (silanol groups) of another first binder, a dehydration-condensation reaction between the hydroxyl groups (silanol groups) of the first binder and the hydroxyl groups of the second binder, a dehydration-condensation reaction between the hydroxyl groups (silanol groups) of the first binder and the hydroxyl groups of the photocatalytic particles 12, and a dehydration-condensation reaction between the hydroxyl groups (silanol groups) of the first binder and hydroxyl groups of the base material 3 proceed, and the dehydrated condensates 13 and 14 (siloxane compounds) are gradually formed. Therefore, by sufficiently drying the coating layer 4, a photocatalyst layer 5 having excellent durability and excellent water resistance can be formed.

### Preparation of Photocatalytic Paint

Photocatalytic paints 1 to 20 having the compositions described in Table 1 (mass when the dehydration-condensation reaction has not proceeded) were prepared.

TABLE 1

| | | | | | | | | | Ratio of | | |
|---|---|---|---|---|---|---|---|---|---|---|---|
| | | | | | | | | | Mass of | | Proportion of |
| | | | | | | 20 wt. % | | | Binders to | Ratio of | Total Mass of |
| | | | | | | Photocatalytic | | | Total Mass of | Second | Binders and |
| | | | | | | Dispersion | | | Binders and | Binder | Photocatalyst |
| | Photo- | First Binder | | Second Binder | | Pt-WO₃ | | | Photocatalyst | to First | in Paint Mass |
| | catalytic | Chemical | Content | Chemical | Content | Content | Water | Water | ((1) + (2))/ | Binder | ((1) + (2) + |
| | Paint | Species | (1) | Species | (2) | (3) | Content | Content | ((1) + (2) + (3)) | ((2)/(1)) | (3)) |
| Example 1 | 1 | B-1 | 1.18 g | B-3 | 0.07 g | 5.0 g | 20.0 g | 73.8 g | (20/100) | (5/95) | 6.3 wt. % |
| Example 2 | 2 | B-1 | 0.94 g | B-3 | 0.31 g | 5.0 g | 20.0 g | 73.8 g | (20/100) | (20/80) | 6.3 wt. % |
| Example 3 | 3 | B-1 | 0.42 g | B-3 | 0.83 g | 5.0 g | 20.0 g | 73.8 g | (20/100) | (40/60) | 6.3 wt. % |
| Example 4 | 4 | B-1 | 0.53 g | B-3 | 0.03 g | 5.0 g | 20.0 g | 74.4 g | (10/100) | (5/95) | 5.6 wt. % |
| Example 5 | 5 | B-1 | 0.42 g | B-3 | 0.14 g | 5.0 g | 20.0 g | 74.4 g | (10/100) | (20/80) | 5.6 wt. % |
| Example 6 | 6 | B-1 | 0.19 g | B-3 | 0.37 g | 5.0 g | 20.0 g | 74.4 g | (10/100) | (40/60) | 5.6 wt. % |
| Example 7 | 7 | B-1 | 0.05 g | B-3 | 0.00 g | 5.0 g | 20.0 g | 74.9 g | (1/100) | (5/95) | 5.1 wt. % |
| Example 8 | 8 | B-1 | 0.04 g | B-3 | 0.01 g | 5.0 g | 20.0 g | 74.9 g | (1/100) | (20/80) | 5.1 wt. % |
| Example 9 | 9 | B-1 | 0.02 g | B-3 | 0.03 g | 5.0 g | 20.0 g | 74.9 g | (1/100) | (40/60) | 5.1 wt. % |
| Example 10 | 10 | B-1 | 0.53 g | B-4 | 0.03 g | 5.0 g | 20.0 g | 74.4 g | (10/100) | (5/95) | 5.6 wt. % |
| Example 11 | 11 | B-1 | 0.42 g | B-4 | 0.14 g | 5.0 g | 20.0 g | 74.4 g | (10/100) | (20/80) | 5.6 wt. % |
| Example 12 | 12 | B-1 | 0.19 g | B-4 | 0.37 g | 5.0 g | 20.0 g | 74.4 g | (10/100) | (40/60) | 5.6 wt. % |
| Example 13 | 13 | B-1 + B-2 (1:1) | 0.53 g | B-3 | 0.03 g | 5.0 g | 20.0 g | 74.4 g | (10/100) | (5/95) | 5.6 wt. % |
| Example 14 | 14 | B-1 + B-2 (1:1) | 0.42 g | B-3 | 0.14 g | 5.0 g | 20.0 g | 74.4 g | (10/100) | (20/80) | 5.6 wt. % |
| Example 15 | 15 | B-1 + B-2 (1:1) | 0.19 g | B-3 | 0.37 g | 5.0 g | 20.0 g | 74.4 g | (10/100) | (40/60) | 5.6 wt. % |
| Comparative | 16 | — | — | — | — | 5.0 g | 20.0 g | 75.0 g | (0/100) | (0/0) | 5.0 wt. % |
| Example 1 | | | | | | | | | | | |
| Comparative | 17 | B-1 | 0.50 g | — | — | 5.0 g | 20.0 g | 74.5 g | (10/100) | (0/100) | 5.5 wt. % |
| Example 2 | | | | | | | | | | | |
| Comparative | 18 | B-1 + B-2 (1:1) | 0.50 g | — | — | 5.0 g | 20.0 g | 74.5 g | (10/100) | (0/100) | 5.5 wt. % |
| Example 3 | | | | | | | | | | | |
| Comparative | 19 | B-1 | 1.61 g | B-3 | 0.54 g | 5.0 g | 20.0 g | 72.9 g | (30/100) | (20/80) | 7.1 wt. % |
| Example 4 | | | | | | | | | | | |
| Comparative | 20 | B-1 + B-2 (1:1) | 1.61 g | B-3 | 0.54 g | 5.0 g | 20.0 g | 72.9 g | (30/100) | (20/80) | 7.1 wt. % |
| Example 5 | | | | | | | | | | | |

“Pt—WO₃” in Table 1 represents platinum-supporting tungsten oxide particles (photocatalytic particles).

Preparation of a 20 wt. % photocatalytic dispersion containing the platinum-supporting tungsten oxide particles will be described later.

“B-1” (first binder) in Table 1 represents 3-glycidoxypropyltrihydroxysilane.

3-glycidoxypropyltrihydroxysilane is produced by hydrolysis of 3-glycidoxypropyltriethoxysilane, which is a raw material, in the preparation process of the photocatalytic paint. Since the photocatalytic paint contains Pt—WO₃ or the second binder, the photocatalytic paint is acidic, and the hydrolysis reaction of 3-glycidoxypropyltriethoxysilane proceeds.

“B-2” (first binder) in Table 1 represents 3-aminopropyltrihydroxysilane.

3-aminopropyltrihydroxysilane is produced by hydrolysis of 3-aminopropyltriethoxysilane, which is a raw material, in the preparation process of the photocatalytic paint. Since the photocatalytic paint contains Pt—WO₃ or the second binder, the photocatalytic paint is acidic, and the hydrolysis reaction of 3-aminopropyltriethoxysilane proceeds.

The photocatalytic paints 13 to 15, 18, and 20 contain both 3-glycidoxypropyltrihydroxysilane and 3-aminopropyltrihydroxysilane as first binders, and the ratio (b/a) of the mass b of the 3-aminopropyltrihydroxysilane to the mass a of 3-glycidoxypropyltrihydroxysilane is (1/1). The content of the first binder contained in each of the photocatalytic paints 13 to 15, 18, and 20 in Table 1 is the total mass of 3-glycidoxypropyltrihydroxysilane and 3-aminopropyltrihydroxysilane.

“B-3” (second binder) in Table 1 represents gluconic acid (HOOC—CH(OH)—CH(OH)—CH(OH)—CH(OH)—CH₂OH).

“B-4” (second binder) in Table 1 represents citric acid (HOOC—CH₂—C(OH)(COOH)—CH₂—COOH).

When these components are mixed with water, the liquid is acidic, and therefore the reaction during hydrolysis of 3-glycidoxypropyltriethoxysilane and 3-aminopropyltriethoxysilane, which are the raw materials of “B-1” and “B-2”, is promoted, a reaction with silanol occurs after the hydrolysis, and the binder components are thereby formed.

Pure water was used as the “water” in Table 1. In Table 1, “-” indicates that the paint did not contain the corresponding material.

Table 1 describes the ratio of the mass ((1)+(2)) of the first and second binders to the total mass ((1)+(2)+(3)) of the mass (1) of the first binder, the mass (2) of the second binder, and the mass (3) of the photocatalytic particles.

Table 1 also describes the ratio of the mass (2) of the second binder to the mass (1) of the first binder.

Table 1 also describes the proportion of the total mass ((1)+(2)+(3)) of the first binder, the second binder, and the photocatalytic particles in the mass of the photocatalytic paint.

### Preparation of 20 wt. % Photocatalytic Dispersion

Platinum-supporting tungsten oxide particles (Pt—WO₃), which are photocatalytic particles, were prepared by the following method. Specifically, 200 g of tungsten oxide (available from Kishida Chemical Co., Ltd.) and 1000 mL of pure water were mixed and then dispersed while being irradiated with ultrasonic waves, and a dispersion A of tungsten oxide particles was obtained. Hexachloroplatinum (VI)-hexahydrate (available from Kishida Chemical Co., Ltd., purity: 98.5%) was dissolved in the dispersion A, and a dispersion B of tungsten oxide particles was obtained. The addition amount of the hexachloroplatinum (VI)-hexahydrate was an amount at which the proportion of the weight of elemental platinum to the weight of the tungsten oxide particles was 0.05 wt. %. Platinum-supporting tungsten oxide particles (Pt—WO₃) were then prepared by heating the dispersion B at 100° C. to evaporate the water and fire the dispersion B.

The prepared platinum-supporting tungsten oxide particles were mixed with pure water such that the proportion of the platinum-supporting tungsten oxide particles in the photocatalyst dispersion was 20 mass %. The obtained mixture was then irradiated with ultrasonic waves, and thereby platinum-supporting tungsten oxide particles (average particle size: 175 nm) were dispersed to prepare a 20 wt. % photocatalytic dispersion.

### Preparation of Photocatalytic Paint 1

Components including 3-glycidoxypropyltriethoxysilane as a raw material of 3-glycidoxypropyltrihydroxysilane, gluconic acid, pure water, and the 20 wt. % photocatalytic dispersion were mixed such that the composition of a photocatalytic paint 1 was the composition described in Table 1, and a photocatalytic paint 1 (100 g) having a total solid concentration of 6.3 mass % was obtained. The total solid content concentration is a ratio of the total mass ((1)+(2)+(3)) of the first and second binders and the photocatalytic particles to the mass of the photocatalytic paint. The same applies hereinafter.

In the photocatalytic paint 1, the mass ratio ((1)+(2))/((1)+(2)+(3)) was (20/100), and the mass ratio ((2)/(1)) was (5/95).

### Preparation of Photocatalytic Paint 2

Components including 3-glycidoxypropyltriethoxysilane as a raw material of 3-glycidoxypropyltrihydroxysilane, gluconic acid, pure water, and the 20 wt. % photocatalytic dispersion were mixed such that the composition of a photocatalytic paint 2 was the composition described in Table 1, and a photocatalytic paint 2 (100 g) having a total solid concentration of 6.3 mass % was obtained.

In the photocatalytic paint 2, the mass ratio ((1)+(2))/((1)+(2)+(3)) was (20/100), and the mass ratio ((2)/(1)) was (20/80).

### Preparation of Photocatalytic Paint 3

Components including 3-glycidoxypropyltriethoxysilane as a raw material of 3-glycidoxypropyltrihydroxysilane, gluconic acid, pure water, and the 20 wt. % photocatalytic dispersion were mixed such that the composition of a photocatalytic paint 3 was the composition described in Table 1, and a photocatalytic paint 3 (100 g) having a total solid concentration of 6.3 mass % was obtained.

In the photocatalytic paint 3, the mass ratio ((1)+(2))/((1)+(2)+(3)) was (20/100), and the mass ratio ((2)/(1)) was (40/60).

### Preparation of Photocatalytic Paint 4

Components including 3-glycidoxypropyltriethoxysilane as a raw material of 3-glycidoxypropyltrihydroxysilane, gluconic acid, pure water, and the 20 wt. % photocatalytic dispersion were mixed such that the composition of a photocatalytic paint 4 was the composition described in Table 1, and a photocatalytic paint 4 (100 g) having a total solid concentration of 5.6 mass % was obtained.

In the photocatalytic paint 4, the mass ratio ((1)+(2))/((1)+(2)+(3)) was (10/100), and the mass ratio ((2)/(1)) was (5/95).

### Preparation of Photocatalytic Paint 5

Components including 3-glycidoxypropyltriethoxysilane as a raw material of 3-glycidoxypropyltrihydroxysilane, gluconic acid, pure water, and the 20 wt. % photocatalytic dispersion were mixed such that the composition of a photocatalytic paint 5 was the composition described in Table 1, and a photocatalytic paint 5 (100 g) having a total solid concentration of 5.6 mass % was obtained.

In the photocatalytic paint 5, the mass ratio ((1)+(2))/((1)+(2)+(3)) was (10/100), and the mass ratio ((2)/(1)) was (20/80).

### Preparation of Photocatalytic Paint 6

Components including 3-glycidoxypropyltriethoxysilane as a raw material of 3-glycidoxypropyltrihydroxysilane, gluconic acid, pure water, and the 20 wt. % photocatalytic dispersion were mixed such that the composition of a photocatalytic paint 6 was the composition described in Table 1, and a photocatalytic paint 6 (100 g) having a total solid concentration of 5.6 mass % was obtained.

In the photocatalytic paint 6, the mass ratio ((1)+(2))/((1)+(2)+(3)) was (10/100), and the mass ratio ((2)/(1)) was (40/60).

### Preparation of Photocatalytic Paint 7

Components including 3-glycidoxypropyltriethoxysilane as a raw material of 3-glycidoxypropyltrihydroxysilane, gluconic acid, pure water, and the 20 wt. % photocatalytic dispersion were mixed such that the composition of a photocatalytic paint 7 was the composition described in Table 1, and a photocatalytic paint 7 (100 g) having a total solid concentration of 5.1 mass % was obtained.

In the photocatalytic paint 7, the mass ratio ((1)+(2))/((1)+(2)+(3)) was (1/100), and the mass ratio ((2)/(1)) was (5/95).

### Preparation of Photocatalytic Paint 8

Components including 3-glycidoxypropyltriethoxysilane as a raw material of 3-glycidoxypropyltrihydroxysilane, gluconic acid, pure water, and the 20 wt. % photocatalytic dispersion were mixed such that the composition of a photocatalytic paint 8 was the composition described in Table 1, and a photocatalytic paint 8 (100 g) having a total solid concentration of 5.1 mass % was obtained.

In the photocatalytic paint 8, the mass ratio ((1)+(2))/((1)+(2)+(3)) was (1/100), and the mass ratio ((2)/(1)) was (20/80).

### Preparation of Photocatalytic Paint 9

Components including 3-glycidoxypropyltriethoxysilane as a raw material of 3-glycidoxypropyltrihydroxysilane, gluconic acid, pure water, and the 20 wt. % photocatalytic dispersion were mixed such that the composition of a photocatalytic paint 9 was the composition described in Table 1, and a photocatalytic paint 9 (100 g) having a total solid concentration of 5.1 mass % was obtained.

In the photocatalytic paint 9, the mass ratio ((1)+(2))/((1)+(2)+(3)) was (1/100), and the mass ratio ((2)/(1)) was (40/60).

### Preparation of Photocatalytic Paint 10

Components including 3-glycidoxypropyltriethoxysilane as a raw material of 3-glycidoxypropyltrihydroxysilane, citric acid, pure water, and the 20 wt. % photocatalytic dispersion were mixed such that the composition of a photocatalytic paint 10 was the composition described in Table 1, and a photocatalytic paint 10 (100 g) having a total solid concentration of 5.6 mass % was obtained.

In the photocatalytic paint 10, the mass ratio ((1)+(2))/((1)+(2)+(3)) was (10/100), and the mass ratio ((2)/(1)) was (5/95).

### Preparation of Photocatalytic Paint 11

Components including 3-glycidoxypropyltriethoxysilane as a raw material of 3-glycidoxypropyltrihydroxysilane, citric acid, pure water, and the 20 wt. % photocatalytic dispersion were mixed such that the composition of a photocatalytic paint 11 was the composition described in Table 1, and a photocatalytic paint 11 (100 g) having a total solid concentration of 5.6 mass % was obtained.

In the photocatalytic paint 11, the mass ratio ((1)+(2))/((1)+(2)+(3)) was (10/100), and the mass ratio ((2)/(1)) was (20/80).

### Preparation of Photocatalytic Paint 12

Components including 3-glycidoxypropyltriethoxysilane as a raw material of 3-glycidoxypropyltrihydroxysilane, citric acid, pure water, and the 20 wt. % photocatalytic dispersion were mixed such that the composition of a photocatalytic paint 12 was the composition described in Table 1, and a photocatalytic paint 12 (100 g) having a total solid concentration of 5.6 mass % was obtained.

In the photocatalytic paint 12, the mass ratio ((1)+(2))/((1)+(2)+(3)) was (10/100), and the mass ratio ((2)/(1)) was (40/60).

### Preparation of Photocatalytic Paint 13

Components including 3-glycidoxypropyltriethoxysilane as a raw material of 3-glycidoxypropyltrihydroxysilane, 3-aminopropyltriethoxysilane as a raw material of 3-aminopropyltrihydroxysilane, gluconic acid, pure water, and the 20 wt. % photocatalytic dispersion were mixed such that the composition of a photocatalytic paint 13 was the composition described in Table 1, and a photocatalytic paint 13 (100 g) having a total solid concentration of 5.6 mass % was obtained.

In the photocatalytic paint 13, the mass ratio ((1)+(2))/((1)+(2)+(3)) was (10/100), and the mass ratio ((2)/(1)) was (5/95).

### Preparation of Photocatalytic Paint 14

Components including 3-glycidoxypropyltriethoxysilane as a raw material of 3-glycidoxypropyltrihydroxysilane, 3-aminopropyltriethoxysilane as a raw material of 3-aminopropyltrihydroxysilane, gluconic acid, pure water, and the 20 wt. % photocatalytic dispersion were mixed such that the composition of a photocatalytic paint 14 was the composition described in Table 1, and a photocatalytic paint 14 (100 g) having a total solid concentration of 5.6 mass % was obtained.

In the photocatalytic paint 14, the mass ratio ((1)+(2))/((1)+(2)+(3)) was (10/100), and the mass ratio ((2)/(1)) was (20/80).

### Preparation of Photocatalytic Paint 15

Components including 3-glycidoxypropyltriethoxysilane as a raw material of 3-glycidoxypropyltrihydroxysilane, 3-aminopropyltriethoxysilane as a raw material of 3-aminopropyltrihydroxysilane, gluconic acid, pure water, and the 20 wt. % photocatalytic dispersion were mixed such that the composition of a photocatalytic paint 15 was the composition described in Table 1, and a photocatalytic paint 15 (100 g) having a total solid concentration of 5.6 mass % was obtained.

In the photocatalytic paint 15, the mass ratio ((1)+(2))/((1)+(2)+(3)) was (10/100), and the mass ratio ((2)/(1)) was (40/60).

### Preparation of Photocatalytic Paint 16

Pure water and the 20 wt. % photocatalytic dispersion were mixed such that the composition of a photocatalytic paint 16 was the composition described in Table 1, and a photocatalytic paint 16 (100 g) having a total solid concentration of 5.0 mass % was obtained.

The photocatalytic paint 16 did not contain the first and second binders.

### Preparation of Photocatalytic Paint 17

Components including 3-glycidoxypropyltriethoxysilane as a raw material of 3-glycidoxypropyltrihydroxysilane, pure water, and the 20 wt. % photocatalytic dispersion were mixed such that the composition of a photocatalytic paint 17 was the composition described in Table 1, and a photocatalytic paint 17 (100 g) having a total solid concentration of 5.5 mass % was obtained.

In the photocatalytic paint 17, the mass ratio ((1)+(2))/((1)+(2)+(3)) was (10/100). The photocatalytic paint 17 did not contain the second binder.

### Preparation of Photocatalytic Paint 18

Components including 3-glycidoxypropyltriethoxysilane as a raw material of 3-glycidoxypropyltrihydroxysilane, 3-aminopropyltriethoxysilane as a raw material of 3-aminopropyltrihydroxysilane, pure water, and the 20 wt. % photocatalytic dispersion were mixed such that the composition of a photocatalytic paint 18 was the composition described in Table 1, and a photocatalytic paint 18 (100 g) having a total solid concentration of 5.5 mass % was obtained. In the photocatalytic paint 18, the mass ratio ((1)+(2))/((1)+(2)+(3)) was (10/100). The photocatalytic paint 18 did not contain the second binder.

### Preparation of Photocatalytic Paint 19

Components including 3-glycidoxypropyltriethoxysilane as a raw material of 3-glycidoxypropyltrihydroxysilane, gluconic acid, pure water, and the 20 wt. % photocatalytic dispersion were mixed such that the composition of a photocatalytic paint 19 was the composition described in Table 1, and a photocatalytic paint 19 (100 g) having a total solid concentration of 7.1 mass % was obtained.

In the photocatalytic paint 19, the mass ratio ((1)+(2))/((1)+(2)+(3)) was (30/100), and the mass ratio ((2)/(1)) was (20/80).

### Preparation of Photocatalytic Paint 20

Components including 3-glycidoxypropyltriethoxysilane as a raw material of 3-glycidoxypropyltrihydroxysilane, 3-aminopropyltriethoxysilane as a raw material of 3-aminopropyltrihydroxysilane, gluconic acid, pure water, and the 20 wt. % photocatalytic dispersion were mixed such that the composition of a photocatalytic paint 20 was the composition described in Table 1, and a photocatalytic paint 20 (100 g) having a total solid concentration of 7.1 mass % was obtained.

In the photocatalytic paint 20, the mass ratio ((1)+(2))/((1)+(2)+(3)) was (30/100), and the mass ratio ((2)/(1)) was (20/80).

### Method for Evaluating Photocatalytic Paint and Evaluation Results

### Preparation of Evaluation Photocatalyst Bodies

Evaluation photocatalyst bodies 1 to 20, each including a photocatalyst layer on a substrate, were produced using the photocatalytic paints 1 to 20. The evaluation photocatalyst body 1 was produced using the photocatalytic paint 1, and the evaluation photocatalyst bodies 2 to 20 were also each produced using the photocatalytic paint of the same reference numeral. Two samples were produced for each of the evaluation photocatalyst bodies 1 to 20 (one for a durability test and one for a methylene blue decomposition test).

The following substrate was used as the substrate for producing each of the evaluation photocatalyst bodies 1 to 20.

Substrate: alkali-free glass (vertical length: 50 mm, horizontal length: 50 mm, thickness: 0.5 mm)

First, a treatment (UV ozone cleaning treatment) of irradiating the substrate with ultraviolet light for 30 minutes was carried out using an ultraviolet ozone irradiation device (available from Technovision, Inc., model: UV-312) equipped with a low-pressure mercury lamp. In this manner, the surface of the substrate was hydrophilically modified. Next, the substrate was coated with the photocatalytic paint several times using a trigger spray until the dried coating film (photocatalyst layer) of the photocatalytic paint applied onto the substrate had a thickness (basis weight) of 5.0 g/m², and the coating layer was dried at 25° C. for one day. In this manner, the evaluation photocatalyst bodies 1 to 20, each provided with a photocatalyst layer on the substrate, were obtained.

### Durability Test

A durability test was conducted by the following method. Four mending tapes (tapes obtained by cutting tape of “model number: No. 810-3-12” available from the 3M Company into a size with a length of 50 mm and a width of 12 mm) were attached to the surface of the photocatalyst layer of each of the evaluation photocatalyst bodies 1 to 20 with the four mending tapes being arranged side-by-side. Next, the four mending tapes were peeled off from the surface of the photocatalyst layer. The adhesive surfaces of the four peeled mending tapes were visually observed to confirm the presence or absence of adhesion of the peeled photocatalyst layer.

The evaluation results of the durability of the evaluation photocatalyst bodies 1 to 20 are presented in Table 2. The criteria for evaluating the durability were as indicated below.

Good: Adhesion of the photocatalyst layer peeled from the substrate was not observed on any of the four mending tapes.

Marginal: Adhesion of the photocatalyst layer peeled from the substrate was observed on one of the four mending tapes.

Poor: Adhesion of the photocatalyst layer peeled from the substrate was observed on two or more of the four mending tapes.

TABLE 2

| | | | | Methylene Blue Decomposition Test | | |
|---|---|---|---|---|---|---|
| | | Durability Test | | Reflectance | | |
| | Photocatalytic | Presence/Absence | | Difference | | Comprehensive |
| | Paint | of Adherence | Evaluation | δd | Evaluation | Evaluation |
| Example 1 | 1 | No adhesion | Good | 15% | Good | Good |
| Example 2 | 2 | No adhesion | Good | 15% | Good | Good |
| Example 3 | 3 | No adhesion | Good | 15% | Good | Good |
| Example 4 | 4 | No adhesion | Good | 10% | Good | Good |
| Example 5 | 5 | No adhesion | Good | 10% | Good | Good |
| Example 6 | 6 | No adhesion | Good | 10% | Good | Good |
| Example 7 | 7 | No adhesion | Good | 6% | Good | Good |
| Example 8 | 8 | No adhesion | Good | 6% | Good | Good |
| Example 9 | 9 | No adhesion | Good | 6% | Good | Good |
| Example 10 | 10 | No adhesion | Good | 10% | Good | Good |
| Example 11 | 11 | No adhesion | Good | 10% | Good | Good |
| Example 12 | 12 | No adhesion | Good | 10% | Good | Good |
| Example 13 | 13 | No adhesion | Good | 10% | Good | Good |
| Example 14 | 14 | No adhesion | Good | 10% | Good | Good |
| Example 15 | 15 | No adhesion | Good | 10% | Good | Good |
| Comparative | 16 | Adhesion to 4 | Poor | 2% | Good | Poor |
| Example 1 | | tapes | | | | |
| Comparative | 17 | Adhesion to 1 | Marginal | 10% | Good | Marginal |
| Example 2 | | tape | | | | |
| Comparative | 18 | Adhesion to 1 | Marginal | 10% | Good | Marginal |
| Example 3 | | tape | | | | |
| Comparative | 19 | No adhesion | Good | 25% | Poor | Poor |
| Example 4 | | | | | | |
| Comparative | 20 | No adhesion | Good | 25% | Poor | Poor |
| Example 5 | | | | | | |

In the durability test of the evaluation photocatalyst bodies 1 to 15, 19, and 20, each formed using the respective photocatalytic paint 1 to 15 (Examples 1 to 15) or photocatalytic paint 19 or 20 (Comparative Examples 4 and 5), each of the evaluation photocatalyst bodies 1 to 15, 19, and 20 was evaluated as being “good”. It is thought that because these photocatalytic paints contained both the first binder and the second binder, the photocatalyst layer was strongly bonded to the substrate in each of these cases.

In the durability test, the evaluation photocatalyst body 16 formed using the photocatalytic paint 16 (Comparative Example 1) was evaluated as being “poor”. It is thought that because the photocatalytic paint 16 did not contain the first binder or the second binder, bonding of the photocatalyst layer to the substrate was weak.

The durability test, the evaluation photocatalyst bodies 17 and 18 formed using the photocatalytic paints 16 and 17 (Comparative Examples 2 and 3) were evaluated as being “marginal”. It is thought that because the photocatalytic paints 17 and 18 contained the first binder but did not contain the second binder, the bonding property of the photocatalyst layer to the substrate was weaker than that of evaluation photocatalyst bodies 1 to 15, 19, and 20.

### Methylene Blue Decomposition Test

A methylene blue decomposition test (measurement of methylene blue fading rate), which is a test for confirming photocatalytic activity, was carried out by the method presented below using each of the evaluation photocatalyst bodies 1 to 20. Using a micropipette, 20 μL of a methylene blue reagent having a concentration of 100 mol/L was dropped onto the photocatalyst layer of the evaluation photocatalyst body. The methylene blue reagent added dropwise onto the evaluation photocatalyst body was dried at room temperature. Next, the evaluation photocatalyst body was continuously irradiated for 24 hours with ultraviolet light having an emission peak wavelength of 365 nm and an irradiance of 2.5 mW/cm² using an ultraviolet lamp. The fading rate of methylene blue dropped on the photocatalyst layer of the evaluation photocatalyst body was then measured. The fading rate of methylene blue was determined by measuring the reflection density of methylene blue on the photocatalyst layer using a black-and-white reflection densitometer (“R700” available from Ihara Electronic Industries Co., Ltd.) and determining a difference δ in reflectance (unit: %). Note that fading of methylene blue was caused by photodecomposition of the methylene blue dropped on the photocatalyst layer of the evaluation photocatalyst body. A smaller difference δd in reflectance indicating the fading rate of methylene blue indicates better methylene blue decomposition activity of the photocatalyst layer formed by the photocatalytic paint.

Table 2 presents the measurement results of the methylene blue fading rate of the evaluation photocatalyst bodies 1 to 20. The evaluation criteria used in the methylene blue decomposition test were as indicated below.

Good: The difference δd in reflectance was less than 20%.

Marginal: The difference δd in reflectance was from 20% to less than 50%.

Poor: The difference δd in reflectance was from 50% to 100%.

In the methylene blue decomposition test of the evaluation photocatalyst bodies 1 to 18, each formed using the respective photocatalytic paint 1 to 15 (Examples 1 to 15) or photocatalytic paint 16 to 18 (Comparative Examples 16 to 18), each of the evaluation photocatalyst bodies 1 to 18 was evaluated as being “good”. It is thought that the photocatalytic activity was not inhibited by the binders because the ratio of the mass of the binders to the total mass of the binders and the photocatalyst in these photocatalytic paints was smaller than (20/100).

In the methylene blue decomposition test, the evaluation photocatalyst bodies 19 and 20 formed using the photocatalytic paints 19 and 20 (Comparative Examples 19 and 20), respectively, were evaluated as being “poor”. It is thought that the photocatalytic activity was inhibited by the binders because the ratio of the mass of the binders to the total mass of the binders and the photocatalyst in these photocatalytic paints was (30/100).

Table 2 presents the results of a comprehensive evaluation of the evaluation photocatalyst bodies 1 to 20 with regard to the durability test and the methylene blue decomposition test. The evaluation criteria of the comprehensive evaluation are shown below.

Good: In the durability test and methylene blue decomposition test, there was no evaluation of marginal or poor.

Marginal: In the durability test and methylene blue decomposition test, an evaluation of marginal occurred, but there was no evaluation of poor.

Poor: There was at least one poor (no good) evaluation in the durability test and methylene blue decomposition test.

1. A photocatalytic paint comprising:
photocatalytic particles containing tungsten oxide;
a binder; and
an aqueous dispersion medium,
the binder comprising a first binder and a second binder, or comprising a dehydrated condensate of the first binder and the second binder,
the first binder being a compound containing a trihydroxysilane group, or a dehydrated condensate of the compound, and
the second binder being an aliphatic hydroxy acid or an aldonic acid.

2. The photocatalytic paint according to claim 1, wherein the compound containing a trihydroxysilane group is a compound represented by chemical formula (1): R₁—Si(OH)₃, where R₁ represents an organic group having an epoxy group, an organic group having an amino group, an organic group having a methacryl group, or an organic group having a mercapto group, and
the second binder is a compound having from 1 to 5 hydroxy groups and from 1 to 3 carboxyl groups.

3. The photocatalytic paint according to claim 2, wherein R₁ in chemical formula (1) represents a 3-glycidoxypropyl group, a 3-aminopropyl group, a 3-methacryloxypropyl group, or a 3-mercaptopropyl group.

4. The photocatalytic paint according to claim 1, wherein a ratio (b/a) of a mass (b) of the binder to a total mass (a) of the photocatalytic particles and the binder in the photocatalytic paint is from (1/100) to (25/100).

5. The photocatalytic paint according to claim 1, wherein a ratio (c/a) of a mass (c) of the photocatalytic particles to a total mass (a) of the photocatalytic particles and the binder in the photocatalytic paint is from (75/100) to (99/100).

6. The photocatalytic paint according to claim 1, wherein a ratio (e/d) of a mass (e) of the second binder to a mass (d) of the first binder in the photocatalytic paint is from (5/95) to (40/60).

7. The photocatalytic paint according to claim 1, wherein the second binder is gluconic acid, citric acid, malic acid, or lactic acid.

8. The photocatalytic paint according to claim 1, further comprising a preservative, wherein the preservative comprises at least one of copper ions, silver ions, or zinc ions.

9. A photocatalyst coating method comprising:
forming a coating layer by applying the photocatalytic paint described in claim 1 onto a base material; and
naturally drying the coating layer.

10. A photocatalyst-coated article comprising:
a base material; and
a photocatalyst layer provided on the base material,
the photocatalyst layer comprising photocatalytic particles containing tungsten oxide, and a dehydrated condensate of a first binder and a second binder,
the first binder being a compound containing a trihydroxysilane group, or a dehydrated condensate of the compound, and
the second binder being an aliphatic hydroxy acid or an aldonic acid.
